(19) United States
(12) Patent Application Publication
(10) Pub. No.: US 2005/0166219 A1
(43) Pub. Date: Jul. 28, 2005

(54) Method and apparatus for providing access protection in a digital television distribution system

(76) Inventors: Annie O. Chen, Del Mar, CA (US); Arthur P. Jost, Mt. Laurel, NJ (US); Robert J. Stone, Poway, CA (US); John Sanders, Ramona, CA (US)

Correspondence Address: Kin-Wah Tong;Moser, Patterson & Sheridan, LLP, Suite 100, 595 Shrewsbury Avenue, Shrewsbury, NJ, 07702, US

(21) Appl. No.: 10/762,972

(22) Filed: Jan. 22, 2004

(51) Int. Cl. H04N 7/167

(52) U.S. Cl. 725/31; 725/63

(57) ABSTRACT

A method and apparatus for providing access protection in a digital television distribution system having a master headend and at least one local headend is described. In one example, first authorization data associated with content services for distribution is defined. The content services are protected at the master headend. The first authorization data is protected at the master headend. Digital transport stream data is then generated from the protected content services and the protected authorization data for transmission to each of the local headends.

### BACKGROUND OF THE INVENTION

1. Field of the Invention

The present invention generally relates to digital television distribution systems and, more particularly, to providing access protection in a digital television distribution system.

2. Description of the Related Art

There is an increased demand for distribution of television services among small clusters of subscribers dispersed widely across a particular region. To meet this demand, television distribution systems typically employ a two-stage delivery architecture. A central station (referred to herein as a “master headend”) provides television services (referred to herein as “content services”) to numerous local stations (referred to herein as “local headends”) via a satellite link. Each of the local headends provides television services to a group of subscribers via a cable television network. In turn, each of the subscribers employs a receiver for receiving the television services from the cable television network and formatting the services for display on a television (referred to herein as a “set-top box” or “STB”).

Typically, the provided content services are encrypted or “scrambled”. Thus, only authorized subscribers may receive, decrypt, and view the content services. Conventionally, in a hybrid satellite and cable television distribution system, encryption systems are employed at both the master headend and each of the local headends. The master headend encrypts the data to be transmitted over the satellite link to the local headends. In turn, each of the local headends decrypts the encrypted data and re-encrypts the content services for distribution to subscriber STBs. Such an architecture is costly, however, as an encryption system is required at each of the local headends to perform the re-encryption process.

### SUMMARY OF THE INVENTION

A method and apparatus for providing access protection in a digital television distribution system having a master headend and at least one local headend is described. In one embodiment, first authorization data associated with content services for distribution is defined. The content services are protected at the master headend. The first authorization data is protected at the master headend. Digital transport stream data is then generated from the protected content services and the protected authorization data for transmission to each of the local headends. For example, in one embodiment, the first authorization data comprises entitlement management messages (EMMs) configured to authorize set-top boxes for viewing particular content services.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a digital television distribution system in accordance with one or more aspects of the invention;

FIG. 2 is a flow diagram depicting a process for providing access protection in a digital television distribution system having a satellite uplink portion and a satellite downlink portion;

FIG. 3 is a block diagram depicting an exemplary embodiment of a master headend shown in FIG. 1;

FIG. 4 is a flow diagram depicting an exemplary embodiment of a two-tier content/satellite-link protection process for use with the master headend shown in FIG. 3;

FIG. 5 is a data flow diagram depicting an exemplary embodiment of the flow of data and control information in the master headend shown in FIG. 3;

FIG. 6 is a block diagram depicting an exemplary embodiment of a local headend shown in FIG. 1; and

FIG. 7 is a flow diagram depicting an exemplary embodiment of a process for distributing content services from the local headend shown in FIG. 6.

To facilitate understanding, identical reference numerals have been used, wherever possible, to designate identical elements that are common to the figures.

### DETAILED DESCRIPTION OF THE INVENTION

FIG. 1 is a block diagram depicting a digital television distribution system 100 in accordance with one or more aspects of the invention. The system 100 comprises a master headend 102 in communication with a local headend 104 via a satellite 110. The master headend 102 transmits television signals via an antenna 108 over an uplink 114. The local headend 104 receives the television signals via an antenna 112 over a downlink 116. The local headend 104 distributes the television signals to subscriber set top boxes (“STBs 106”) over a cable transmission path 107. The master headend 102 is referred to herein as the “satellite uplink portion” of the digital television distribution system 100. The local headend 104 is referred to herein as the “satellite downlink portion” of the digital television distribution system 100.

While only a single local headend is shown, it is to be understood that the satellite downlink portion of the system 100 may comprise any number of local headends, where each local headend serves a group of subscriber STBs. In addition, for purposes of clarity by example, the system 100 is shown with respect to a satellite link between the master headend 102 and the local headend 104. It is to be understood, however, that any type of shared distribution medium or combination of shared distribution media may be employed, such as a satellite link, a fiber distribution network, a terrestrial broadcast medium, the Internet, or other shared distribution medium known in the art, or any combination of such shared distribution media.

The master headend 102 comprises a satellite link protection component 120 and a content protection component 122. The content protection component 122 protects content services (e.g., audio/video program services) provided by the distribution system 100 to provide conditional access thereto. Notably, the content protection component 122 may define authorization data for authorizing particular ones of the STBs 106 to decode particular content services (“content authorization data”). For example, the content authorization data may include entitlement management messages (EMMs), virtual channel tables (VCTs), and like type rights management messages known in the art. In addition, the content protection component 122 may encrypt the data defining the content services using well-known cryptographic techniques. For example, entitlement control messages (ECMS) may be generated to specify access rules for particular content services and to convey cryptographic information for computing cryptographic keys within the STBs 106.

The master headend 102 generates one or more digital transport streams for conveying the protected content services (e.g., the content services and the content authorization data) for distribution to the local headend 104 and the STBs 106. For example, the content services may comprise data compressed in accordance with an MPEG (Moving Pictures Expert Group) standard, such as MPEG-2 as defined by ISO/IEC Standard 13818, and the digital transport streams may comprise MPEG-2 transport streams. The satellite link protection component 120 protects the digital transport streams transmitted to, and relayed by, the satellite 110. Embodiments of the satellite link protection process are described below. In this manner, the master headend 102 provides centralized satellite-link and content conditional access systems, thereby obviating the need to include encryption components to protect the content in each of the local headends 104.

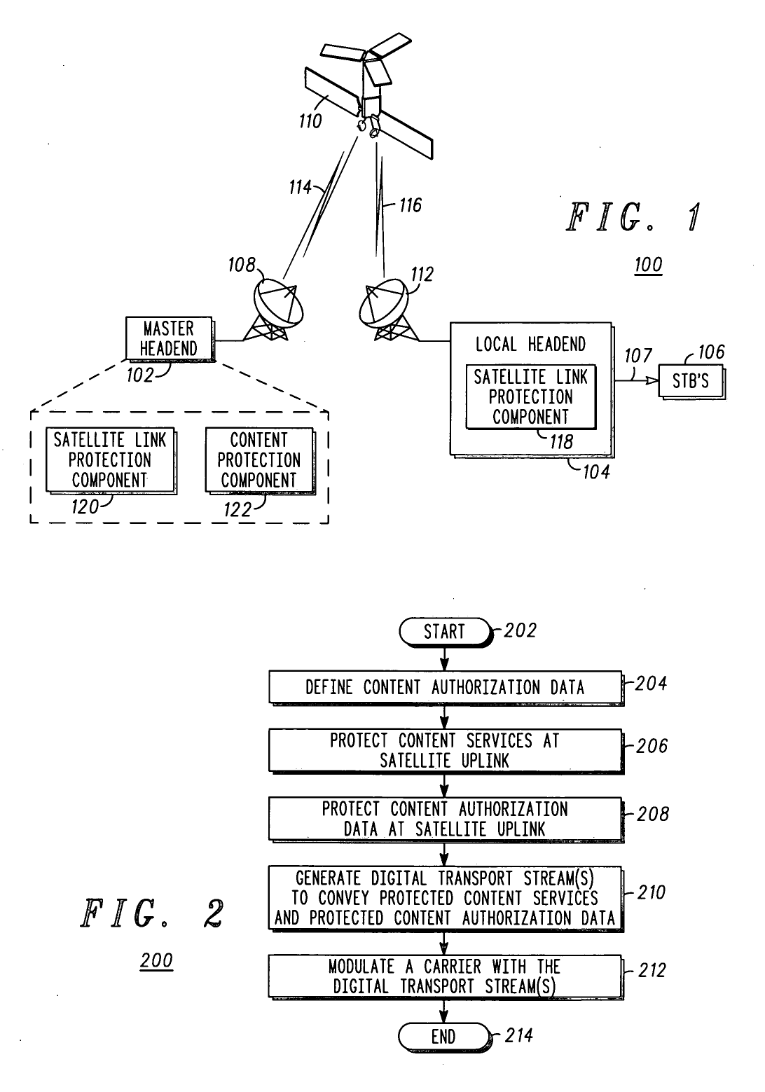

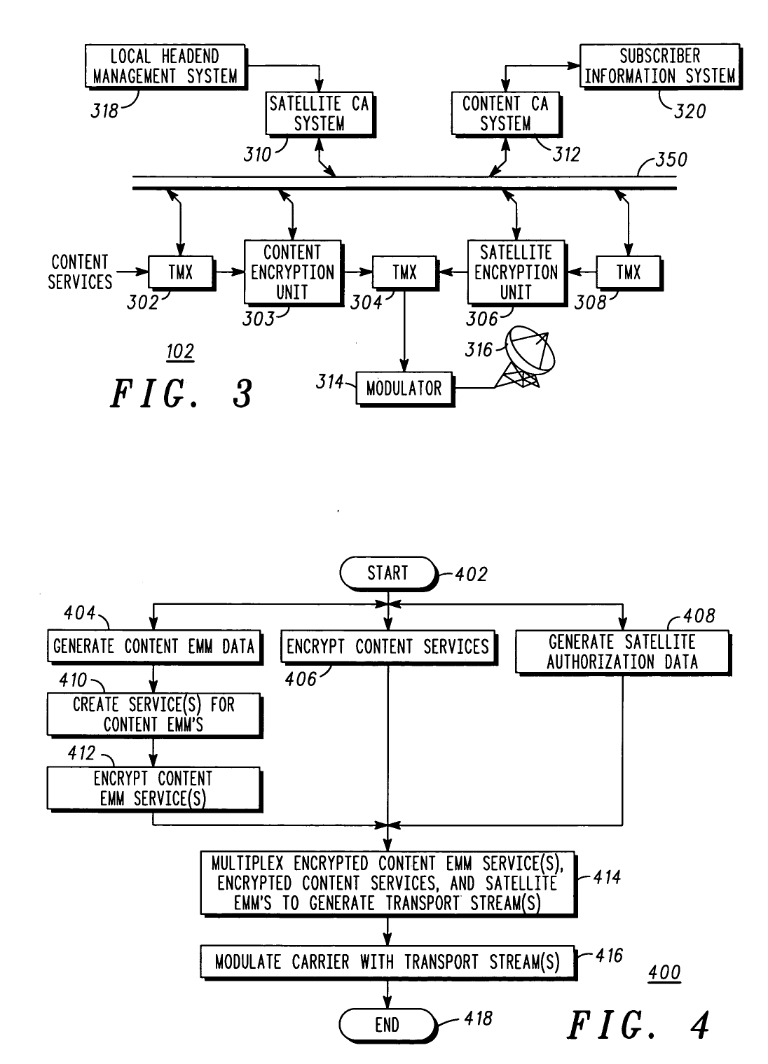

FIG. 2 is a flow diagram depicting a process 200 for providing access protection in a digital television distribution system having a satellite uplink portion and a satellite downlink portion. The process 200 starts at step 202. At step 204, authorization data is defined for various content services to be distributed (e.g., EMMs, VCTs, and the like). At step 206, the content services are protected at the satellite uplink portion of the distribution system (e.g., the content services may be encrypted). At step 208, the content authorization data defined in step 204 is protected at the satellite uplink portion of the distribution system (e.g., the content authorization data may be encrypted).

At step 210, one or more digital transport streams (e.g., MPEG-2 transport streams) are generated to convey the protected content services and the protected authorization data to the satellite downlink portion. At step 212, a carrier is modulated with the one or more digital transport streams. The process 200 ends at step 214. Thus, the satellite link between the satellite uplink portion and the satellite downlink portion (e.g., between the master headend and the local headends) is protected by the protection of the content authorization data. Without access to the content authorization data, none of the subscriber STBs can be authorized to receive the content services.

FIG. 3 is a block diagram depicting an exemplary embodiment of the master headend 102 of FIG. 1. The master headend 102 illustratively comprises a transport stream multiplexer (TMX) 302, a content encryption unit 303, a TMX 304, a satellite link encryption unit 306, a TMX 308, a satellite CA system 310, a content CA system 312, a modulator 314, and an antenna 316. A first port of the satellite CA system 310 is coupled to a local headend management system 318. A first port of the content CA system 312 is coupled to a subscriber information system 320. Second ports of the satellite CA system 310 and the content CA system 312 are coupled to a network 350. In addition, ports of the TMX 302, the content encryption unit 303, the TMX 304, the satellite link encryption unit 306, and the TMX 308 are each coupled to the network 350.

An input port of the TMX 302 receives content services. An input port of the content encryption unit 303 is coupled to an output port of the TMX 302. An input port of the TMX 304 is coupled to an output port of the content encryption unit 303. Another input port of the TMX 304 is coupled to an output port of the satellite link encryption unit 306. An input port of the satellite link encryption unit 306 is coupled to an output port of the TMX 308. An output port of the TMX 304 is coupled to an input port of the modulator 314. An output port of the modulator 314 is coupled to the antenna 316.

Each of the TMX 302, the TMX 304, and the TMX 308 are capable of multiplexing data to generate one or more digital transport streams, such as MPEG-2 transport streams. Each of the content encryption unit 303 and the satellite encryption unit 306 are capable of encrypting data input thereto using well-known cryptographic techniques, such as DES (data encryption standard), CSA (common scrambling algorithm), or AES (Advanced Encryption Standard) encryption techniques as embodied in MediaCipher or DigiCipher implementations commercially available by Motorola, Inc. The satellite CA system 310 may provide authorization information to authorize satellite RDs in the local headends (e.g., satellite-link EMMs), as well as control information to facilitate protection of the data transmitted over the satellite link from unauthorized access (e.g., encryption and transport stream control information). The satellite CA system 310 may receive local headend information from a local headend management system 318, such as which local headends are authorized to process particular transport streams.

The content CA system 312 may provide authorization information to authorize subscriber STBs (e.g., content EMMs), as well as control information to facilitate protection of the content carried by the transport streams. The content CA system 312 may receive subscriber information from a subscriber information system 320, such as which subscribers are authorized to view particular content services. The modulator 314 may be any type of satellite uplink modulator known in the art. For example, the modulator 314 may be a quadrature phase shift keying (QPSK) modulator (e.g., a digital video broadcast (DVB) modulator), or a DigiCipher® II modulator, commercially available from Motorola, Inc.

FIG. 4 is a flow diagram depicting an exemplary embodiment of a two-tier content/satellite-link protection process 400 for use with the master headend 102 shown in FIG. 3. The process 400 begins at step 402. At step 404, EMM data for the content services is generated. The content EMM data may comprises one or more EMM streams used to authorize subscriber STBs for viewing particular content services. At step 410, one or more services are created for carrying the content EMM data (“content EMM services”). Each of the content EMM services may comprise one or more EMM streams and a program map table (PMT). The PMT includes packet identifier (PID) information for identifying the component EMM streams. The content EMM services may be “dummy services”, which are not identified in the channel map and are thus invisible to the subscriber STBs.

At step 412, the content EMM services formed at step 410 are encrypted. At step 406, the content services are encrypted. At step 408, authorization data for the satellite link is generated (“satellite-link authorization data”). The satellite-link authorization data is used to authorize satellite receiver/decoders (satellite RDs) employed at the local headends for decrypting particular content EMM services. For example, the satellite-link authorization data may comprise EMM data for authorizing satellite RDs at the local headends (“satellite EMM data”). Without authorization, the satellite RDs at the local headends will not be able to decrypt the content EMM data, and thus the subscriber STBs will not be able to view the content services associated therewith. At step 414, the encrypted content EMM services, the encrypted content services, and the satellite-link authorization data are multiplexed to generate a transport stream. At step 416, a carrier is modulated with the transport stream for transmission over a satellite link. The process 400 ends at step 418.

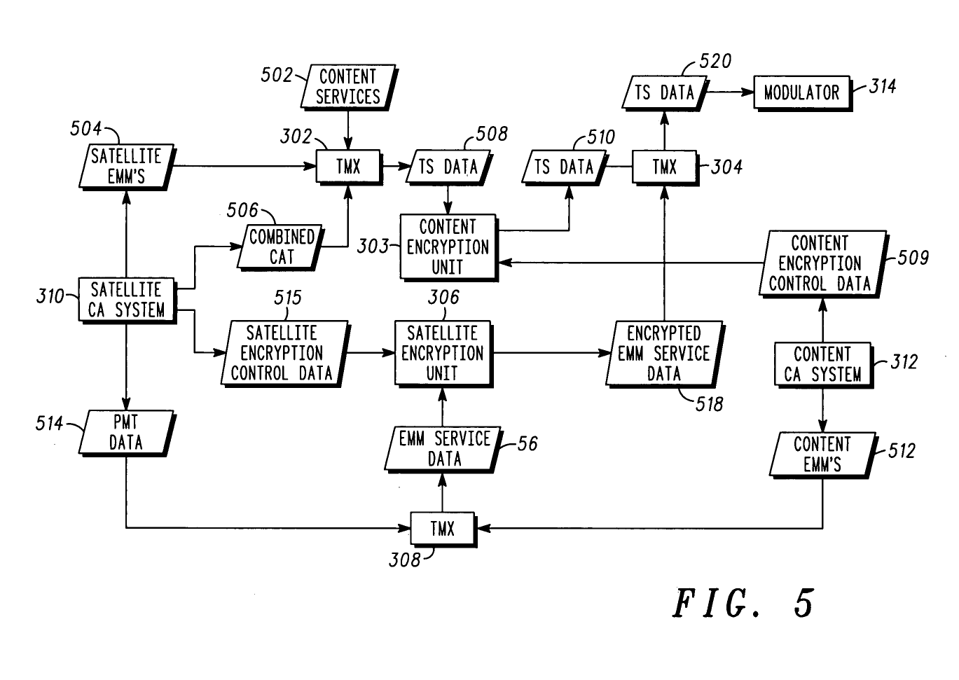

FIG. 5 is a data flow diagram depicting an exemplary embodiment of the flow of data and control information in the master headend 102 of FIG. 3. Content services 502 are provided to the TMX 302. The TMX 302 also receives satellite EMM data 504 and a combined conditional access table (CAT) 506 from the satellite CA system 310. The contents of the combined CAT 506 are described below. The TMX 302 multiplexes the content services 502, the satellite EMM data 504, and the combined CAT 506 to generate transport stream data 508. The content services carried by the transport stream data 508 are encrypted by the content encryption unit 303 in response to content encryption control data 509 provided by the content CA system 312. The content encryption unit 303 provides transport stream data 510 to the TMX 304.

The TMX 308 receives content EMM data 512 from the content CA system 310. The content EMM data 512 is used to authorize the subscriber STBs. The TMX 308 generates EMM service data 516 for carrying the content EMM data 512 in response to PMT data 514 from the satellite CA system 310. The TMX 308 provides content EMM service data 516 to the satellite encryption unit 306. The satellite encryption unit 306 encrypts the content EMM service data 516 in response to satellite encryption control data 515 provided by the satellite CA system 310. The satellite encryption unit 306 provides encrypted content EMM service data 518 to the TMX 304. The combined CAT 506 includes a descriptor to identify the satellite EMM data 504 and one or more descriptors to identify one or more content EMM services, respectively, in the EMM service data 516.

The TMX 304 multiplexes the transport stream data 510 (i.e., transport stream data with encrypted content services) and the encrypted content EMM service data 518 to generate transport stream data 520. The transport stream data 520 is provided to the modulator 314. The modulator 314 modulates a carrier with the transport stream data 520.

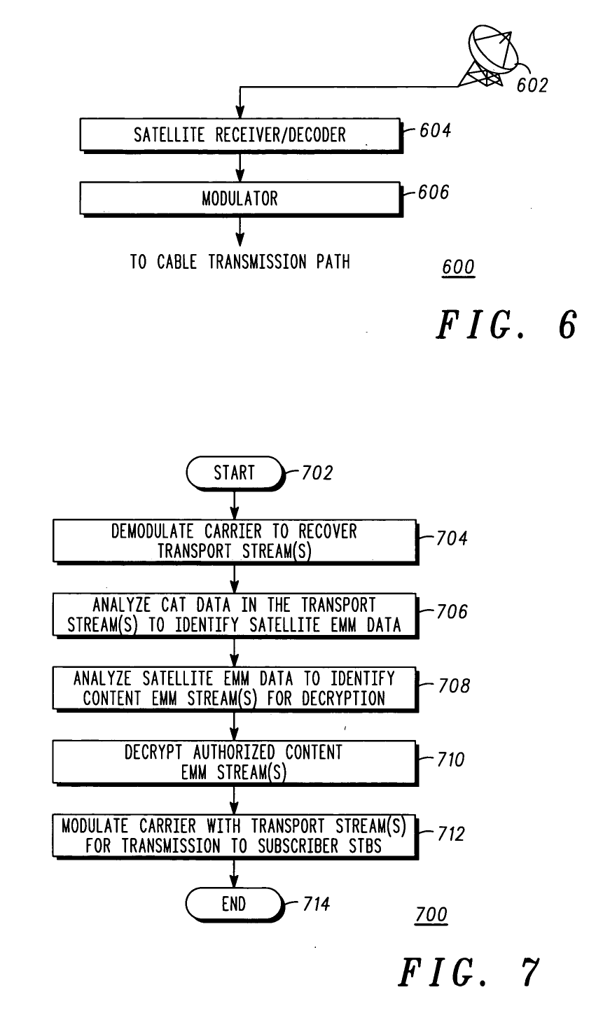

FIG. 6 is a block diagram depicting an exemplary embodiment of the local headend 104 of FIG. 1. The local headend 104 illustratively comprises an antenna 602, a satellite receiver/decoder (“satellite RD 604”) and a modulator 606. The modulated carrier generated by the master headend 102 is received at the local headend 104 using the antenna 602. An input port of the satellite RD 604 receives the modulated carrier from the antenna 602. The satellite RD 604 is capable of demodulating the carrier to recover one or more digital transport streams therefrom (e.g., QPSK demodulation). In addition, the satellite RD 604 is capable of processing the digital transport streams to select and decrypt one or more content EMM services. An input port of the modulator 606 receives the transport streams from the satellite RD 604 having clear content EMM data. The modulator 606 modulates a carrier with the one or more transport streams in a well-known manner for transmission over a cable transmission path. For example, the modulator 606 may employ quadrature amplitude modulation (QAM) for transmission over a hybrid fiber/coaxial cable (HFC) cable television network.

FIG. 7 is a flow diagram depicting an exemplary embodiment of a process 700 for distributing content services from a local headend. The process 700 may be performed by the local headend 104 shown in FIG. 6. The process 700 begins at step 702. At step 704, the carrier received from the master headend over the satellite link is demodulated to recover one or more transport streams. At step 706, CAT data in the transport streams is analyzed to identify satellite EMM data. As described above, a CAT in the transport stream includes a descriptor pointing to the satellite EMM data. At step 708, the satellite EMM data is analyzed to identify one or more content EMM streams for decryption. That is, the satellite EMM data authorizes the local headend to decrypt one or more of the content EMM streams that were encrypted by the master headend. At step 710, the authorized content EMM streams are decrypted. Content EMM streams of which the local headend is not authorized to decrypt pass through the local headend. At step 712, a carrier is modulated with the transport streams for transmission to subscriber STBs over a cable transmission network.

A method and apparatus for providing access protection in a digital television distribution system having a satellite uplink portion and a satellite downlink portion has been described. One or more aspects of the invention relate to protecting authorization data, such as EMMs, associated with content services at the satellite uplink portion. Encrypting the content authorization data at the satellite uplink limits or prevents unauthorized access to the satellite link. At the satellite downlink portion, the encrypted content authorization data may be decrypted before distribution to subscriber STBs in response to satellite authorization data generated by the satellite uplink portion.

While the foregoing is directed to illustrative embodiments of the present invention, other and further embodiments of the invention may be devised without departing from the basic scope thereof, and the scope thereof is determined by the claims that follow.

1. A method of providing access protection in a digital television distribution system having a m1 aster headend and at least one local headend, comprising:
defining first authorization data associated with content services;
protecting said content services at said master headend;
protecting said first authorization data at said master headend; and
generating digital transport stream data from said protected content services and said protected authorization data for transmission to each said at least one local headend.

2. The method of claim 1, further comprising:
defining second authorization data associated with said digital transport stream data; and
multiplexing said second authorization data with said digital transport stream data.

3. The method of claim 1, wherein said first authorization data comprises first entitlement management messages configured to authorize set-top boxes for viewing said content services, and wherein said step of protecting said content services comprises encrypting said content services.

4. The method of claim 3, wherein said step of protecting said first authorization data comprises:
generating at least one service in response to said first entitlement management messages; and
encrypting said at least one service to generate encrypted service data.

5. The method of claim 4, further comprising:
defining second entitlement management messages configured to authorize receiver circuitry of each said at least one local headend for decrypting one or more services of said encrypted service data; and
multiplexing said second entitlement management messages with said digital transport stream data.

6. The method of claim 5, further comprising:
modulating a carrier with said digital transport stream data;
transmitting said carrier to each said at least one local headend via a shared distribution medium;
demodulating said carrier at each said at least one local headend to recover said digital transport stream data; and
decrypting one or more services of said encrypted service data in response to said second entitlement management messages.

7. The method of claim 6, further comprising:
modulating a second carrier with said digital transport stream data; and
transmitting said second carrier over a cable transmission path to set-top boxes.

8. An apparatus for providing access protection in a digital television distribution system having a master headend and at least one local headend, the apparatus comprising:
a first conditional access system for defining first authorization data associated with content services;
a first encryption unit, disposed in said master headend, for encrypting said content services;
a second encryption unit, disposed in said master headend, for encrypting said first authorization data; and
a multiplexer for multiplexing said encrypted content services and said encrypted first authorization data to generate digital transport stream data for transmission to each said at least one local headend over a shared distribution medium.

9. The apparatus of claim 8, further comprising:
a second conditional access system for defining second authorization data associated with said digital transport stream data;
where said multiplexer multiplexes said second authorization data with said digital transport stream data.

10. The apparatus of claim 8, wherein said first authorization data comprises first entitlement management messages configured to authorize set-top boxes for viewing said content services.

11. The apparatus of claim 10, further comprising:
a second multiplexer for multiplexing said first entitlement management messages with control data to generate at least one service;
where said second encryption unit encrypts said at least one service to generate encrypted service data.

12. The apparatus of claim 11, further comprising:
a second conditional access system for defining second entitlement management messages configured to authorize receivers of each said at least one local headend for decrypting one or more services of said encrypted service data
wherein said multiplexer multiplexes said second entitlement management messages with said digital transport stream data.

13. The apparatus of claim 8, wherein said shared distribution medium comprises at least one of a satellite link, a terrestrial broadcast link, a fiber distribution medium, and the Internet.

14. A digital television distribution system, comprising:
a master headend for transmitting television signals over a shared distribution medium, said master headend comprising:
a first conditional access system for defining first authorization data associated with content services;
a first encryption unit for encrypting said content services;
a second encryption unit for encrypting said first authorization data;
a multiplexer for multiplexing said encrypted content services and said encrypted first authorization data to generate digital transport stream data; and
a modulator for modulating a carrier with said digital transport stream data; and
a local headend for receiving said television signals from said satellite, said local headend comprising:
a demodulator for demodulating said carrier to recover said digital transport stream data; and
a decoder for decrypting said first authorization data.

15. The system of claim 14, wherein said master headend further comprises:
a second conditional access system for defining second authorization data associated with said digital transport stream data;
where said multiplexer multiplexes said second authorization data with said digital transport stream data.

16. The system of claim 14, wherein said first authorization data comprises first entitlement management messages configured to authorize set-top boxes for viewing said content services.

17. The system of claim 16, wherein said master headend further comprises:
a second multiplexer for multiplexing said first entitlement management messages with control data to generate at least one service;
where said second encryption unit encrypts said at least one service to generate encrypted service data.

18. The system of claim 17, wherein said master headend further comprises:
a second conditional access system for defining second entitlement management messages configured to authorize said decoder of said local headend for decrypting one or more services of said encrypted service data
wherein said multiplexer multiplexes said second entitlement management messages with said digital transport stream data.

19. The system of claim 14, wherein said shared distribution medium comprises at least one of a satellite link, a terrestrial broadcast link, a fiber distribution medium, and the Internet.

20. An apparatus for providing access protection in a digital television distribution system having a master headend and at least one local headend, the method comprising:
means for defining first authorization data associated with content services;
means for protecting said content services at said master headend;
means for protecting said first authorization data at said master headend; and
means for generating digital transport stream data from said protected content services and said protected authorization data for transmission to each said at least one local headend over a shared distribution medium.
